(19) United States
(12) Patent Application Publication
(10) Pub. No.: US 2009/0287550 A1
(43) Pub. Date: Nov. 19, 2009

(54) SYSTEM AND METHOD FOR MONITORING DRIVE THRU PERFORMANCE

(76) Inventor: Matt Jennings, Ham Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/121,460

(22) Filed: May 15, 2008

(51) Int. Cl. G06F 11/34; G06Q 10/00; G06F 9/44; G06F 17/30

(52) U.S. Cl. 705/11; 705/7; 707/104.1; 707/10; 707/E17.044; 707/E17.009

(57) ABSTRACT

In one embodiment, the method comprises operating one or more monitoring devices for recording and interpreting vehicle presence data and communicating vehicle presence data to a remote database. The method further comprises generating performance reports, the performance reports being based on the vehicle presence data.

### FIELD OF THE INVENTION

The present disclosure relates to a system and method for monitoring entity's providing drive-thru service. More particularly, the present disclosure relates to a system and method for remotely monitoring the arrival, stay, and departure of a customer using an entity's drive-thru service.

### BACKGROUND

For entities having drive-thru services, providing efficient service is an important factor in maintaining profitability. For example, at quick service restaurants (QSRs) providing a drive-thru service, it is desirable to take and deliver the food and/or beverage orders as quickly as possible following arrival of the vehicle at the drive-thru entrance, in order to serve as many customers as possible, as well as to optimize customer satisfaction. Accordingly, monitoring of drive-thru service performance may constitute an invaluable practice for entities providing drive-thru service.

Drive-thru performance monitoring by means of vehicle detection sensors is well known and has gained widespread recognition by entities employing a drive-thru service, such as QSRs, drive-up bank teller systems, and the like. In such systems, for example, a vehicle drives up or across a designated detection area, such as a remote order taking station for placing a food or drink order without physically entering the entity building. A sensor embedded in the detection area has a given inductance which changes as a result of the vehicle coming in close proximity to the sensor. This change in inductance is communicated to a monitoring device located inside the entity building which records and interprets the communication to provide a meaningful output, such as for example, duration of stay or wait time. Management or other supervisory personnel within the entity may then access this information in printed form or electronically, such as at a desktop personal computer, for example.

Onsite access to drive-thru performance data, while instructive, is of little use to management located offsite. For example, as is typical, management of a QSR enterprise may oversee several QSR locations which comprise the enterprise, and may infrequently be physically present at the QSR. Accordingly, it is desirable to have the ability to conveniently and efficiently access drive-thru performance information for one or more QSRs from a remote location.

### BRIEF SUMMARY OF THE INVENTION

A system and method for monitoring entity's providing drive-thru service is provided. More particularly, a system and method for remotely monitoring the arrival, stay, and departure of a customer using an entity's drive-thru service is provided.

In one embodiment, a method for remotely tracking data related to an entity's drive-thru performance is provided. In one embodiment, the method comprises operating one or more monitoring devices for recording and interpreting vehicle presence data and communicating vehicle presence data to a remote database. The method then comprises generating performance reports, the performance reports being based on the vehicle presence data.

In a further embodiment, a remote drive-thru performance tracking system is provided. In one embodiment, the system comprises one or more monitoring devices, at least one control box, a database for storing information related to drive-thru performance, and a central processor. The control box is operatively associated with the one or more monitoring devices such that control box receives vehicle presence data from the monitoring device. The database is in communication with the control box such that the control box sends information regarding drive-thru performance to the database remotely. The central processor is operatively associated with the database and include software for tracking drive-thru performance data.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a schematic diagram of an entity providing a drive-thru service in accordance with one embodiment.

FIG. 2 is a block diagram depicting a drive-thru performance monitoring system in accordance with one embodiment.

FIG. 3 is a block diagram depicting the tracking of drive-thru performance data in accordance with one embodiment.

FIG. 4 is a block diagram depicting the tracking of drive-thru point of sale data in accordance with one embodiment.

FIG. 5 illustrates an exemplary drive-thru performance report in accordance with one embodiment.

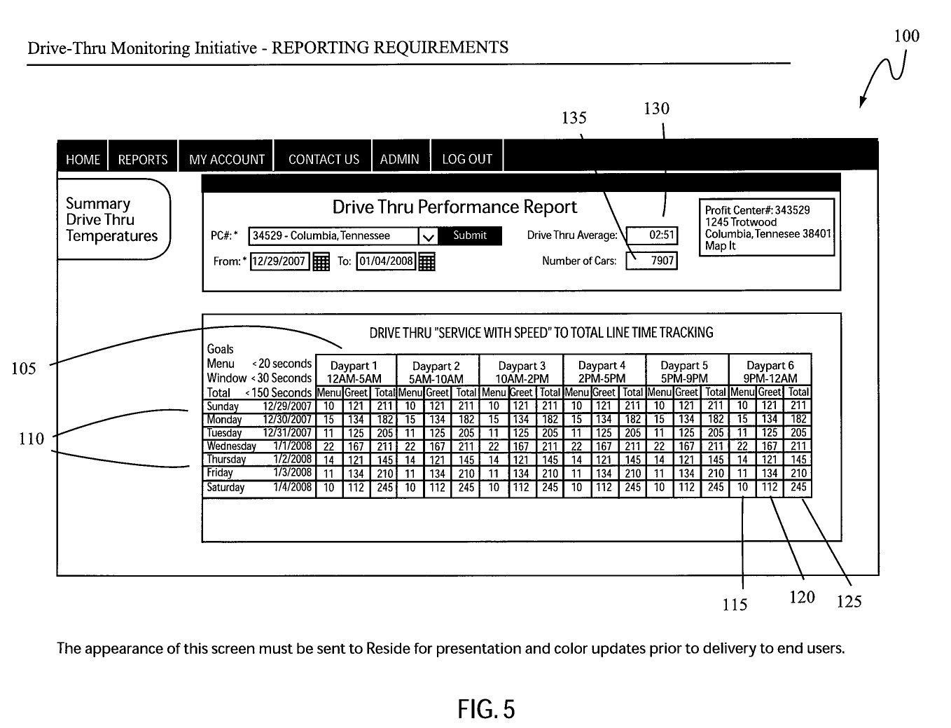

FIG. 6 illustrates an exemplary drive-thru performance report in accordance with one embodiment.

FIG. 7 illustrates an exemplary drive-thru performance report in accordance with one embodiment.

### DETAILED DESCRIPTION

### A. Overview

The present disclosure relates to a system and method for monitoring entity's providing drive-thru service. In one embodiment, the system and method may include remotely monitoring the arrival, stay, and departure of a customer using an entity's drive-thru service. On the basis of this information, the system and method may generate reports detailing, for example, the performance of an entity's drive-thru service.

While the system and method of the present disclosure may be used by any entity having a drive-thru service, the system and method of the present disclosure have specific application to quick service restaurant-type (QSR) entities having a drive-thru service in which food and/or beverage orders may be placed and picked up without leaving a motor vehicle.

The system and method of the present disclosure may be used by entities providing drive-thru service, and specifically QSRs to, for example, more easily access information related to its drive-thru performance. Additionally, for example, the system and method of the present disclosure allows an entity's management to access, from a central location, consolidated drive thru performance data for one or more of its locations. For example, for a QSR enterprise that comprises one or more QSR locations, the system and method of the present disclosure provides management a single resource to consult regarding drive-thru service performance of one or more of its QSR locations. Consequently, the system and method of the present disclosure provides entity management with a consolidated resource, for each of its locations, to determine daily demand patterns and to detect trends, to isolate periods of efficient and inefficient operation, and to objectively assess whether drive-thru service at one or more of its locations is underperforming.

### B. System Configuration

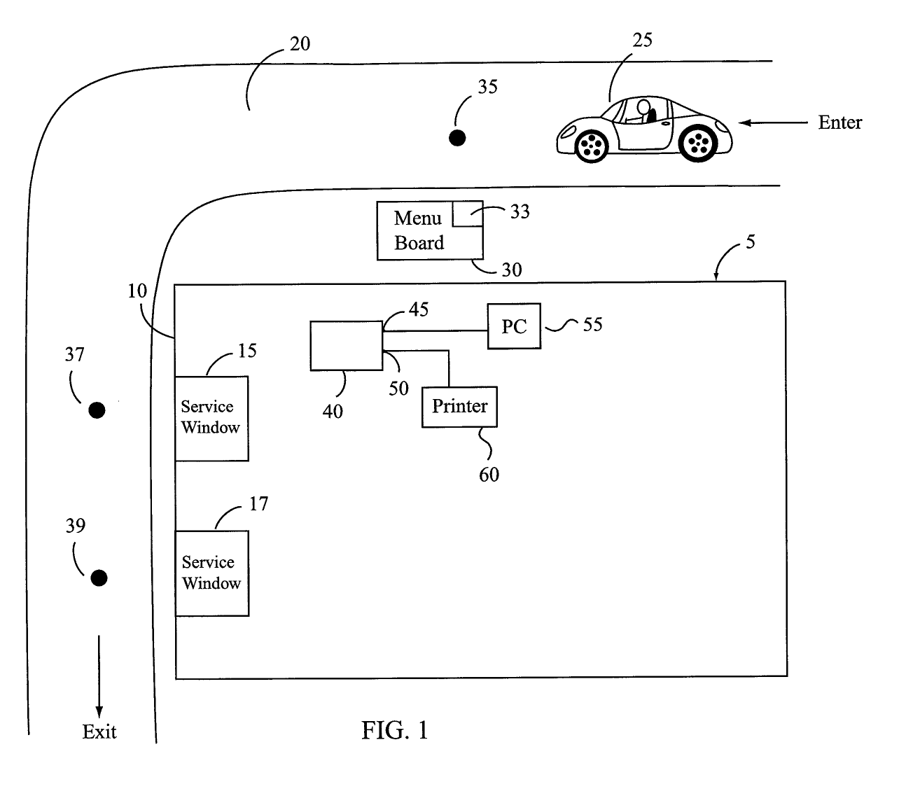

FIG. 1 illustrates an exemplary prior art system for tracking drive thru performance data from a restaurant having a drive-thru or drive-in window. As shown, the system includes a restaurant building 5 having the usual equipment where food, beverage, or other products are prepared and packaged for carry-out. The restaurant building 5 includes a wall 10 in which a first service window 15 and a second service window 17 are mounted such that customers may physically interact with restaurant employees. In some systems, first service window 15 may comprise a cashier window and second service window 17 may comprise an order retrieval window. In alternative systems, only a first service window 15, functioning as both a cashier window and order retrieval window, may be provided. A driveway or vehicle approach lane 20 extends alongside one or more walls of the restaurant building 5 to permit vehicles to access service windows 15 and 17. Generally, approach lane 20 is of sufficient length to accommodate several successive vehicles 25. In many instances, a menu board 30 listing various items to be purchased is located along the approach lane 20 at a distance from the service windows 15 and 17. Typically, communication means, such as an intercom 33, are provided in or near the menu board 30 which allow a customer to communicate remotely with a restaurant employee to place an order. Additionally, in some systems, a communication sensor for detecting conversation between employees and customers is also provided.

As is known, one or more detecting means, such as for example sensors 35, 37, and 39, may be provided in or around the driveway 20 to detect the arrival and presence of a motor vehicle 25 in the driveway 20. Typically, detecting means are provided near the menu board 30 and service windows 15 and 17 to enable monitoring of a customer throughout the customer's visit.

As is also known, either or both of the communication means and detecting means may be in electronic communication with a monitoring device 40 located within the restaurant building 5. Generally, the monitoring device 40 receives and interprets electronic signals from the communication means and/or detecting means to monitor the arrival and duration of stay of a customer in a motor vehicle 25 using the drive-thru service. A suitable monitoring device for use with the system and method of the present disclosure is a Fast Track 2+2 Drive-Thru Timer manufactured by Phase Research, of Santa Ana, Calif.

Such prior art systems may, for example, be used to produce a meaningful output regarding the arrival, stay, and/or departure of a motor vehicle 25. Specifically, such systems may provide the number of customers using the drive-thru service over a selected period and one or more performance times. Performance times, generally, may refer to an elapsed time corresponding to a defined portion of the customer's drive-thru experience. For example, a total service time which corresponds to the elapsed time between the arrival of a vehicle at the menu board 30 and the departure of that vehicle from the second service window 17, may be provided. Additional performance times, as will be discussed below, may also be provided.

In prior art systems, such as illustrated in FIG. 1, monitoring device 40 may be provided with a networking port 45 and/or printing port 50. As shown, networking port 45 may provide a communication link between the monitoring device 40 and a local display means 55, such as a desktop personal computer. Similarly, as also shown, the printer port 50 may provide a communication link between the monitoring device 40 and local printer 60. Generally, the drive-thru performance data may be viewed by restaurant personnel electronically via the local display means 55 or in printed form via the local printer 60. That is, communication of drive-thru performance data is limited to local communication within the restaurant building 5.

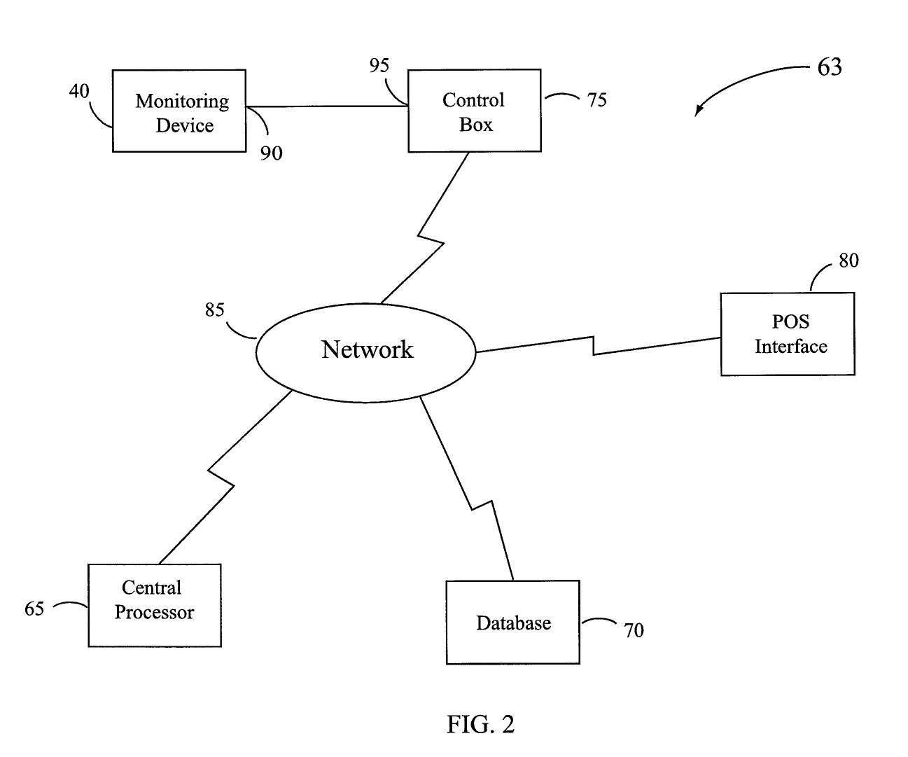

In some embodiments, the system and method of the present disclosure enables remote monitoring of drive-thru performance data. In one embodiment, illustrated in FIG. 2, a remote monitoring system 63 may comprise a central processor 65 located at a central location, one or more databases 70 to store system data, and one or more monitoring devices 40 located at a plurality of restaurant locations, each having an associated control box 75. In one embodiment, each of the control boxes 75 may be equipped with means to communicate with the central processor 65 and database 70 over a network 85, such as the Internet. Additionally, the system may comprise a plurality of drive-thru point of sale (“POS”) interfaces 80 located at a plurality of restaurant locations, each equipped with means to communicate with the central processor 65 and database 70 over the network 85.

The central processor 65 may be any computer known to those skilled in the art, including standard attachments and components thereof (e.g., a disk drive, hard drive, CD player or network server that communicates with a CPU and main memory, a sound board, a keyboard and mouse, and a monitor).

The central processor 65 may include software programs or instructions that process requests and responses from a user of the remote monitoring system 63. These software programs or instructions send information to and receive information from the database 70, perform compilation and storage functions, and generate reports that may be viewed by users of the system 63. The software may be software applications commercially sold and normally used by those skilled in the art or they may be specific applications coded for use with the system disclosed herein.

The system 63 may also include one or more databases 70 for storing system data. The database may be of any type generally known in the art. In one embodiment, the database 70 may be integral to the central processor 65. In an alternative embodiment, the database 70 may be accessible to the central processor through network 85 or other suitable communication link. In one embodiment, the database 70 is comprised of a plurality of database servers, some of which are integral to the central processor 65, and some that are located remotely from the central processor 65. In some embodiments, as will be discussed in greater detail below, the database 70 may store any information relating to the performance of a restaurant's drive-thru service (“drive-thru performance data”).

As shown, the system 63 may include one or more monitoring devices 40. As previously discussed, a suitable monitoring device for use with the system and method of the present disclosure is a Fast Track 2+2 Drive-Thru Timer manufactured by Phase Research, of Santa Ana, Calif. In some embodiments, monitoring device 40 may include or more communication ports 90 for transmitting data. In some embodiments, the monitoring device 40 may be programmed to transmit data on a periodic basis, such as every minute, for example. In alternative embodiments, the monitoring device 40 may be programmed to transmit data upon the occurrence of a triggering event, such as a motor vehicle departing from the second service window, for example.

In some embodiments, a control box 75 may provide a communication link between the monitoring device 40 and database 70 or central processor 65. Control box 75 may comprise any device capable of recording and telecommunications. Is some embodiments, the control box 75 may be capable of recording and communicating in real time. A suitable control box for use with the system and method is a GT-100 Data Manager manufactured by Restaurant Technologies, Inc., of Eagan, Minn. In some embodiments, control box 75 may include one or more inputs 95 for receiving data transmissions from the monitoring device 40.

In some embodiments, the system 63 may include one or more drive-thru POS interfaces 80. POS interfaces 80 may be any computer or computer systems used in the restaurant industry to process customer orders. In one embodiment, the POS interfaces 80 comprise a central processor unit and main memory, an input/output interface for communicating with various databases, files, programs, and networks. The POS interfaces 80 may also have a monitor or other screen device and an input device, such as a keyboard, a mouse, or a touch sensitive screen. In one embodiment, POS interfaces 80 are located in the restaurant building 5 adjacent to one or more of the service windows 15 and 17.

### C. Drive-Thru Performance Data

Prior to implementation of the system and method, or as part of implementation of the system and method, general entity information may be provided and stored to the database 70. For example, if the entity is a QSR enterprise, the general information may include site information relating to all the sites where the QSR has drive-thru service, including site location, and any other relevant site information. In a further embodiment, an identifier may be created for each QSR site providing drive-thru service to give it a trackable identity. In some embodiments, the QSR site identifiers may also be stored to the database 30.

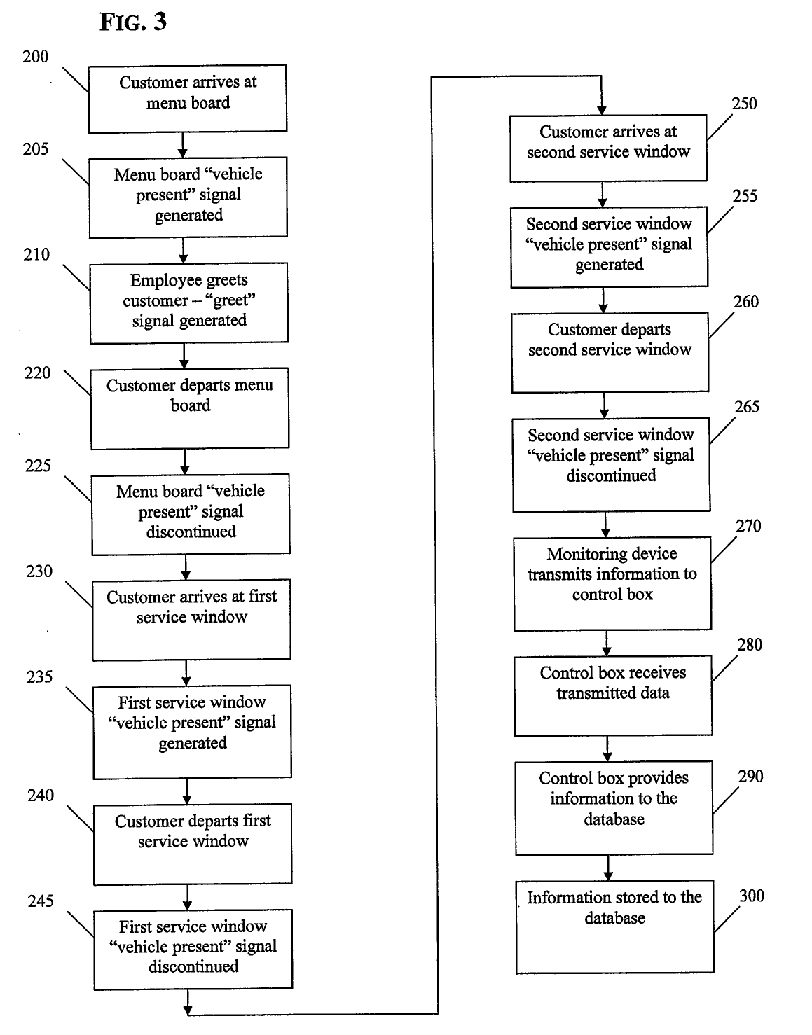

FIG. 3 is a flow chart illustrating the monitoring of drive-thru performance data in accordance with some embodiments. A customer enters the driveway 20 and arrives at the menu board 30, thereby causing the menu board sensor 35 to generate a “vehicle present” signal which is received by monitoring device 40 (block 200). An employee then greets the customer through the intercom 33, thereby causing the intercom sensor to generate a “greet” signal which is received by the monitoring device 40 (block 210). After the customer concludes placement of an order, the vehicle departs the menu board 30 and advances towards the first service window 15 (block 220), thereby causing the “vehicle present” signal of the menu board sensor 35 to be discontinued. The customer then arrives at the first service window 15 (block 230), thereby causing the first service window sensor 37 to generate a “vehicle present” signal which is received by monitoring device 40.

After the customer concludes interaction at the first service window, such as by making payment for example, the vehicle departs the first service window 15 and advances towards the second service window 17 (block 240), thereby causing the “vehicle present” signal of the first service window sensor 37 to be discontinued. The customer then arrives at the second service window 17 (block 250), thereby causing the second service window sensor 39 to generate a “vehicle present” signal which is received by monitoring device 40. Alternatively, if a drive-thru does not have a second service window or the second service window is inactive, the vehicle advances toward the drive-thru exit. After the customer concludes interaction at the second service window 17, such as by receiving an order, the vehicle departs second service window 17 and advances towards the drive-thru exit (block 260), thereby causing the “vehicle present” signal of the second service window sensor 39 to be discontinued.

On the basis of the signals generated by sensors 35, 37, and 39, the monitoring device 40 calculates one or more drive-thru performance statistics. Specific examples of drive-thru performance statistics include the number of vehicles that traveled through the drive-thru over a selected period (the “customer count”) and the total elapsed service time of a particular customer through the drive-thru service (the “total service time”). In one embodiment, the total service time may be approximated as the elapsed time between the arrival of a vehicle at the menu board (block 200) and the departure of that vehicle from the order retrieval window (block 260).

Additionally, drive-thru performance statistics may comprise any or all of greet time, menu time, and first and second service window times. The greet time may refer to the elapsed time between the arrival of a vehicle at the menu board 30 (block 200) and initiation of communication from a restaurant employee (block 210). The menu time may refer to the total elapsed time during a vehicle's presence at the menu board 30, and may be approximated as the elapsed time between arrival of a vehicle at the menu board 30 (block 200) and the departure of that vehicle from the menu board (block 220). The first service window time may refer to the total elapsed time during a vehicle's presence at the first service window 15, and may be approximated as the elapsed time between arrival of a vehicle at the first service window (block 230) and the departure of that vehicle from the first service window (block 240). The second service window time may refer to the total elapsed time during a vehicle's presence at the second service window 17, and may be approximated as the elapsed time between arrival of a vehicle at the second service window (block 250) and the departure of that vehicle from the second service window (block 260).

In some embodiments, upon departure of a vehicle from the order second service window (block 260), the monitoring device 40 transmits information to the control box 75 (block 270). In some embodiments, the monitoring device 40 transmits one or more drive-thru performance statistics associated with the departing customer vehicle. In one embodiment, the monitoring device transmits the total service time, greet time, menu time, and service window times associated with the departing vehicle.

In some embodiments, control box 75 may receive the transmitted data (block 280). The control box 75 may then provide information to the database 30 (block 290). Provision of such information may be in real time or may, in some embodiments, be delayed, such as reporting of information on a timed basis. In some embodiments, the control box may provide any or all of the data transmitted from the monitoring device 40. In one embodiment, the control box 75 provides any or all of the total time, greet time, menu time, and service window times associated with particular customer vehicles.

In some embodiments, the drive-thru performance information provided by the control box 75 may then be stored to the database 70 (block 300). In some embodiments, the system saves all such drive-thru performance information in the database 70 such that the system accumulates all drive-thru performance history.

### D. POS Data

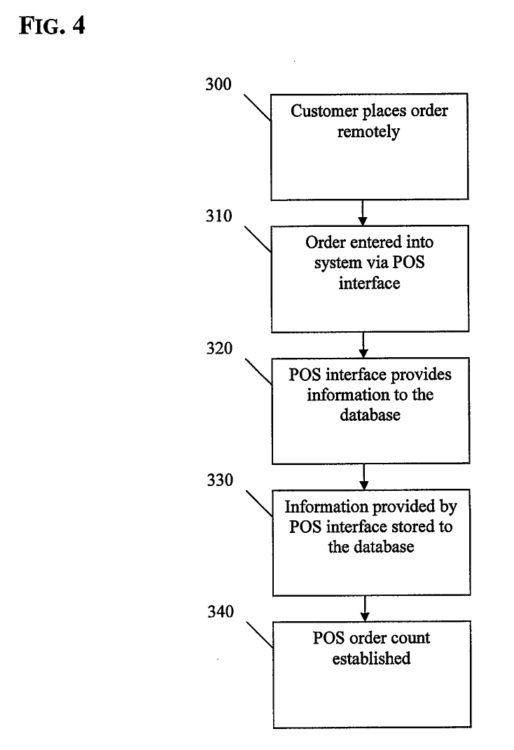

FIG. 4 is a flow chart illustrating the tracking of drive-thru POS data in accordance with one embodiment. Typically, the process may be initiated by a customer placing an order remotely with a restaurant employee at the menu board 30 (block 300). The restaurant employee may then enter the order into the system via the POS interface 80 (block 310).

After an order is entered into the system, in some embodiments, the drive-thru POS interface 80 provides information to the database (block 320). Provision of such information may be in real time or may, in some embodiments, be delayed, such as provision of information on a timed basis. In some embodiments, the POS interface 80 may provide any information relating to the customer order (“POS information”). In one embodiment, the POS interface provides at least the date/time of the order. The information provided by the POS interface 80 may then be stored to the database 70 (block 330). In one embodiment, POS information stored to the database may then be used by the system 63 to establish a drive-thru POS order count for a selected period (block 340).

### D. Report Generation

In some embodiments, on the basis of the stored drive-thru performance data, the system 63 may generate performance reports. In some embodiments, reports may be generated for a single QSR site. Alternatively, in some embodiments, reports may be generated for one or more QSR sites which comprise a QSR enterprise.

In some embodiments, performance reports may comprise any information relating to the arrival, stay, and departure of a customer vehicle, or an identified group of customer vehicles, at a restaurant drive-thru. In one embodiment, the operation reports may comprise one or more drive-thru performance statistics, of one or more QSR sites, for one or more selected time periods.

FIG. 4 is an exemplary embodiment of a performance report according to some embodiments. As illustrated, performance report 100 may provide drive-thru performance statistics for a single restaurant location over a selected seven-day week. In some embodiments, performance report 100 may comprise one or more columns 105 and one or more rows 110. In one embodiment, columns 105 may correspond to a predetermined time segment of a day. For example, as shown, columns 105 may correspond to the following time segments: 12 am-5 am, 5 am-10 am, 10 am-2 pm, 2 pm-5 pm, 5 pm-9 pm, 9 pm-12 am. Alternatively, the columns 105 may correspond to any predetermined time segments which comprise a day.

In some embodiments, each column 105 may also comprise one or more sub-columns. For example, in one embodiment, each column 105 may be provided with sub-columns 115, 120, and 125, corresponding to menu time average, greet time average, and total service time average over a predetermined segment of the day, for a selected period of time, in seconds, respectively. In one embodiment, one or more additional sub-columns corresponding to one or more alternative drive-thru performance statistics, such as service window times for example, may be provided. Alternatively, any number of sub-columns corresponding to any number of drive-thru performance statistics may be provided.

In some embodiments, report 100 may further comprise one or more rows 110 corresponding to a predetermined time period over which drive-thru performance statistics are generated. In one embodiment, as shown, report 100 comprises rows 110 corresponding to days of a selected seven-day week. Alternatively, rows 110 may correspond to any selected time period.

Additionally, in some embodiments, report 100 may comprise one or more drive-thru performance statistics for a selected restaurant location over the entire selected time period. For example, as illustrated, report 100 comprises an total service time average 130 and customer count total 135 for the selected restaurant location over the selected time period.

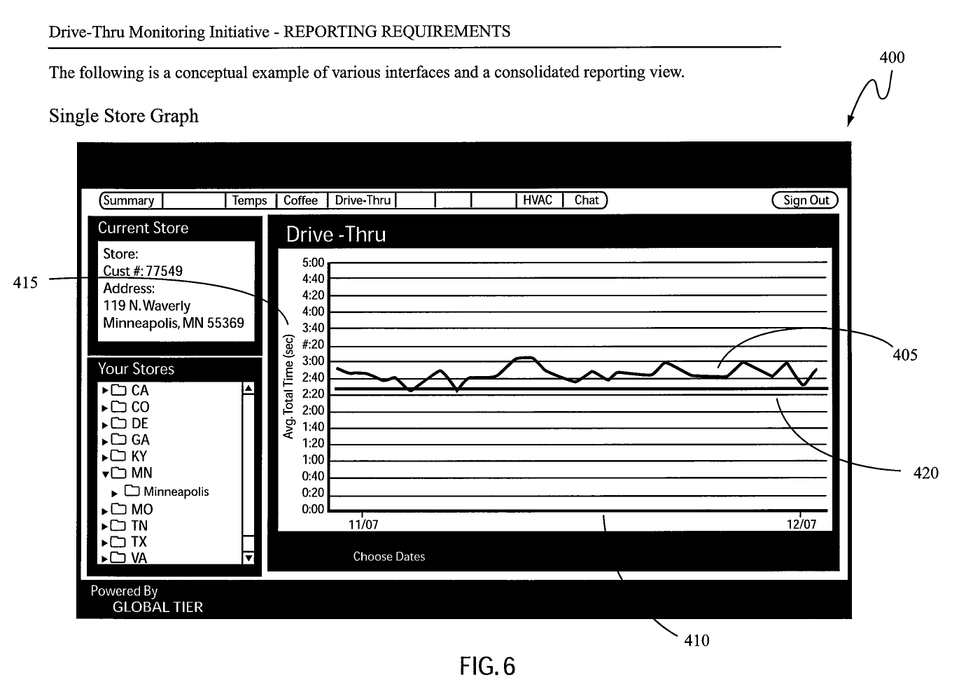

FIG. 6 is an exemplary embodiment of an alternative performance report 400 according to some embodiments. As shown, the report 400 may display operating statistics for a selected restaurant locations over a selected period. In one embodiment, the report 400 may comprise one or more drive-thru performance curves 405 plotted with respect to a horizontal axis 410 and vertical axis 415. In one embodiment, horizontal axis 410 corresponds to a selected time period over which the drive-thru performance curve 405 is to be plotted. For example, as shown, the drive-thru performance curve 405 may be plotted over a one-month period. Alternatively, the drive-thru performance curve 405 may be plotted over any selected period.

In some embodiments vertical axis 410 may correspond to the total service time average for a selected restaurant, in minutes, at a given period in time. Alternatively, the vertical axis 415 may correspond to any drive-thru performance statistic.

Additionally, in one embodiment, report 400 may comprise a performance reference line 420. The performance reference line 420 may, for example, correspond to a predetermined drive-thru performance statistic value that a restaurant may use to objectively assess performance. As illustrated, performance reference line 420 may represent a predetermined total service time that an efficiently performing QSR drive-thru service would not exceed.

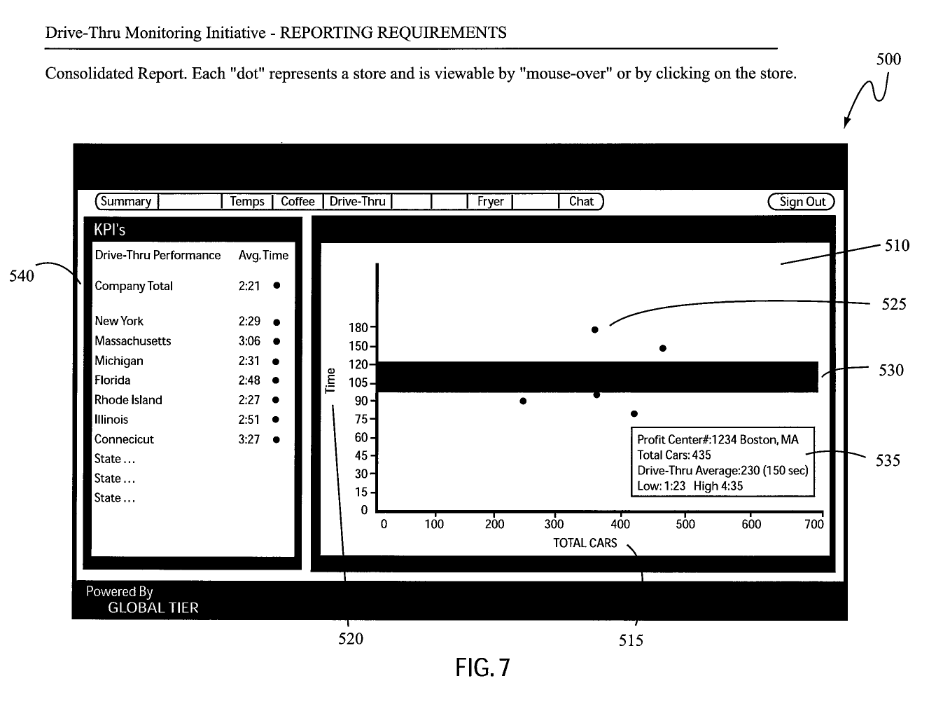

FIG. 7 is an exemplary embodiment of a further alternative performance report 500 according to some embodiments. As shown, the report 500 may display operating statistics for a plurality of selected QSR locations. In one embodiment, the report 500 may comprise a scatter-plot 510 plotted with respect to a horizontal axis 515 and a vertical axis 520. In one embodiment, horizontal axis 515 may correspond to the customer count total for a selected restaurant and the vertical axis 520 may correspond to the total service time average for the selected restaurant, in seconds. Accordingly, each of the data points 525 which comprise the scatter-plot 510 corresponds to a total service time average for an identified total number of customers at a selected QSR. Alternatively, the vertical axis 415 may correspond to any alternative drive-thru performance statistic.

Additionally, in one embodiment, report 500 may comprise a performance reference band 530. The performance reference band 530 may, for example, correspond to a predetermined drive-thru performance statistic value range that a restaurant may use to objectively assess performance. As illustrated, performance reference band 520 may represent a predetermined total service time value range which an efficiently performing QSR drive-thru service would not exceed.

In one embodiment, if the report 500 is viewed in electronic form, such as on a desktop personal computer, the report 500 may comprise an interactive feature 535. Specifically, in one embodiment, if a user “mouses over” a data point 525 of the scatter-plot 510, drive-thru performance statistics 535 for the restaurant corresponding to the selected data point 525 are provided to the user. As shown, the drive-thru performance statistics 535 may comprise the customer count total, average total service time average, low total service time, and high total service time. Alternatively, drive-thru performance statistics 535 may comprise any alternative drive-thru performance statistics or combinations thereof.

In some embodiments, report 500 may further comprise a chart 540 including selected drive-thru performance statistics for a selected group of QSRs 540. As illustrated, the drive-thru performance statistics may be provided for QSRs selected on a geographical basis, such as for example, by state in which the QSR site is located.

In an alternative embodiment, on the basis of the stored drive-thru performance data and stored drive-thru POS data, the system 63 may generate performance reports. In one embodiment, the system may generate performance reports relating the vehicle count data provided by the monitoring devices 40 with the customer order count data provided by the POS interfaces 80. Such a relation, may for example, serve as a form of protection against employee fraud. That is, if the number of vehicles detected by the monitoring devices 40 exceeds the number of customer orders entered into the system via POS interfaces 80, the existence of employee fraud may be inferred.

In some embodiments, the system 63 may be configured to generate performance reports on a periodic basis, such as daily, weekly, or monthly, for example. In an alternative embodiment, the system 63 may be configured to generate performance reports upon the occurrence of a triggering event, such as for example, when one or more drive-thru performance statistics exceeds and/or falls below a predetermined threshold value.

Although the present invention has been described with reference to preferred embodiments, persons skilled in the art will recognize that changes may be made in form and detail without departing from the spirit and scope of the invention.

We claim:

1. A method for remotely tracking data related to an entity's drive-thru performance comprising:
operating one or more monitoring devices for recording and interpreting vehicle presence data;
communicating vehicle presence data to a remote database; and
generating performance reports, the performance reports being based on the vehicle presence data.

2. The method of claim 1, wherein the one or more monitoring devices comprise a plurality of operating devices located at a plurality of entity locations.

3. The method of claim 2, wherein the performance reports comprise one or more drive-thru performance statistics for one or more entity locations.

4. The method of claim 1, wherein the one or more monitoring devices are programmed to communicate vehicle presence data after departure of a customer vehicle from the drive-thru.

5. The method of claim 4, wherein the monitoring device communicates one or more drive-thru performance statistics related to the departed customer vehicle.

6. The method of claim 1, further comprising operating one or more point of sale interfaces for processing drive-thru customer orders and communicating customer order information to the remote database

7. The method of claim 6, wherein the performance reports are based on the vehicle presence data and the customer order information.

8. The method of claim 1, wherein the performance reports are automatically generated on a periodic basis.

9. A remote drive-thru performance tracking system comprising:
one or more monitoring devices;
at least one control box, the control box being operatively associated with the one or more monitoring devices such that control box receives vehicle presence data from the monitoring device;
a database for storing information relating to drive-thru performance, the database being in communication with the control box such that the control box sends information regarding drive-thru performance to the database remotely; and
a central processor operatively associated with the database and including software for tracking drive-thru performance data.

10. The system of claim 9, wherein the one or more monitoring devices comprise a plurality of operating devices located at a plurality of entity locations.

11. The system of claim 9, wherein the central processor further includes software for generating performance reports, the performance reports being based on the vehicle presence data.

12. The system of claim 9, wherein the one or more monitoring devices are programmed to communicate vehicle presence data after departure of a customer vehicle from the drive-thru.

13. The system of claim 12, wherein the monitoring device communicates one or more drive-thru performance statistics related to the departed customer vehicle.

14. The system of claim 11, further comprising one or more point of sale interfaces for processing drive-thru customer orders and communicating customer order information to the database remotely.

15. The system of claim 14, wherein the performance reports are based on the vehicle presence data and the customer order information.

16. The system of claim 11, wherein the performance reports are automatically generated on a periodic basis.
